(19) United States
(12) Patent Application Publication
(10) Pub. No.: US 2004/0140323 A1
(43) Pub. Date: Jul. 22, 2004

(54) Cheese dispenser, in particular parmesan-like cheese

(75) Inventor: Angelo Ricotti, Sant'llario d'Enza (IT)

Correspondence Address: SEED INTELLECTUAL PROPERTY LAW GROUP PLLC, 701 FIFTH AVE, SUITE 6300, SEATTLE, WA, 98104-7092, US

(73) Assignee: Dalter Alimentari S.p.A., Sant'llario d'Enza (IT)

(21) Appl. No.: 10/688,189

(22) Filed: Oct. 17, 2003

(30) Foreign Application Priority Data
Oct. 18, 2002 (IT) MI2002U000481

(51) Int. Cl. B67D 5/64

(52) U.S. Cl. 222/134

(57) ABSTRACT

The present invention relates to a cheese dispenser, particularly mature cheese, such as Parmesan-like cheese and the like, which achieves a remarkable preservation of the organoleptic characteristics of the cheese. The dispenser comprises a container, a grater arranged to inviolably close the container and an external casing.

### BACKGROUND OF THE INVENTION

1. Field of the Invention

The present invention relates to a cheese dispenser, particularly mature cheese, like Parmesan-like cheese and the like.

More specifically, but not exclusively, the invention relates to the packaging, preservation and distribution of dairy food products, such as cheese, and in particular mature cheese such as Parmesan-like cheese, and the following description is made with reference to this field of application for convenience of illustration only.

2. Description of the Related Art

In the last years consumers have shown their increasing liking for some food products, which are available in supermarkets as fresh products, thanks to packaging techniques in an inert atmosphere and/or to preservation techniques at low temperature, e.g., +4° C.

According to the product typology, as well as to the consumer's way of use, some packaging techniques have prevailed through time, which contribute to the preservation of the organoleptic characteristics of the product.

For example as far as dairy products are concerned, such as mature cheeses like Parmesan-like cheese, a packaging technique has long prevailed, which provides the preservation of cheese in loose bags, made of preferably transparent film, and then filled with Parmesan-like cheese, grated (or foliated), preferably in controlled atmosphere.

However, although advantageous under many aspects, these containers have a limited use because, once they are open, they cannot be properly closed anymore to guarantee a good preservation of the product. The last must be therefore consumed within a relatively short time.

Moreover tray measuring devices are used, made of synthetic plastic material, preferably transparent and semi-rigid, filled with Parmesan-like grated cheese and sealed preferably in controlled atmosphere. These tray measuring devices are described in the European Patent Application to the same applicant, no. EP 1 243 522 A1.

These measuring devices, arranged to be well closed up again, give the product a better protection.

However, because of the minimum size of the food product contained in these measuring devices, which size is typical of the grated or foliated status, i.e., thinly divided, the product is subject to a very fast deterioration. So, also these measuring devices leave a lot to be desired as far as a better preservation of the organoleptic characteristics of the product is concerned.

One aim of the present invention is that of providing a cheese dispenser having such structural and functional characteristics as to overcome the drawbacks mentioned with reference to the prior art.

### BRIEF SUMMARY OF THE INVENTION

The above indicated aim is achieved by a dispenser comprising a container and a grater being arranged so as to inviolably close the container.

Further characteristics and advantages of the dispenser according to the invention will become apparent from the following description of an embodiment thereof given by way of indicative and non-limiting example with reference to the attached drawings.

### BRIEF DESCRIPTION OF THE DRAWINGS

In these drawings:

FIG. 1 shows a perspective view of a cheese dispenser according to one embodiment of the invention;

FIG. 2 shows a perspective, partial section of a detail of the dispenser of FIG. 1;

FIG. 3 shows a longitudinal sectional view of the detail of FIG. 2, along line III-III of FIG. 4;

FIG. 4 shows a cross-sectional view of the detail of FIG. 2, along line IV-IV of FIG. 3;

FIG. 5 shows an enlarged scale view of a portion of the detail of FIG. 2, along line V-V of FIG. 4;

FIG. 6 shows a perspective view of the detail of FIG. 2 in another operating step;

FIG. 7 shows a perspective view of a portion of a cheese dispenser according to another embodiment of the invention;

FIG. 8 shows a longitudinal view of a portion of the detail of FIG. 7, along line VIII-VIII of FIG. 9, according to the other embodiment of the invention;

FIG. 9 shows a cross view of a portion of the detail of FIG. 8, along line IX-IX of FIG. 8 according to the other embodiment of the invention;

FIG. 10 shows an enlarged scale view of a portion of the detail of FIG. 7, along line X-X of FIG. 9, according to the other embodiment of the invention; and

FIG. 11 shows a perspective view of the detail of FIG. 7, according to another embodiment of the invention, in another operating step.

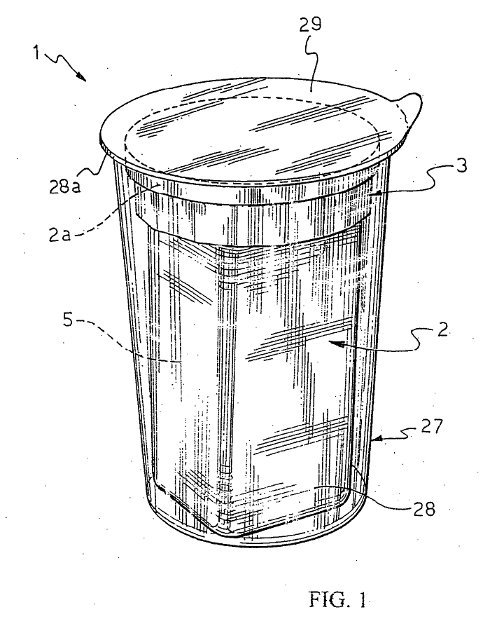

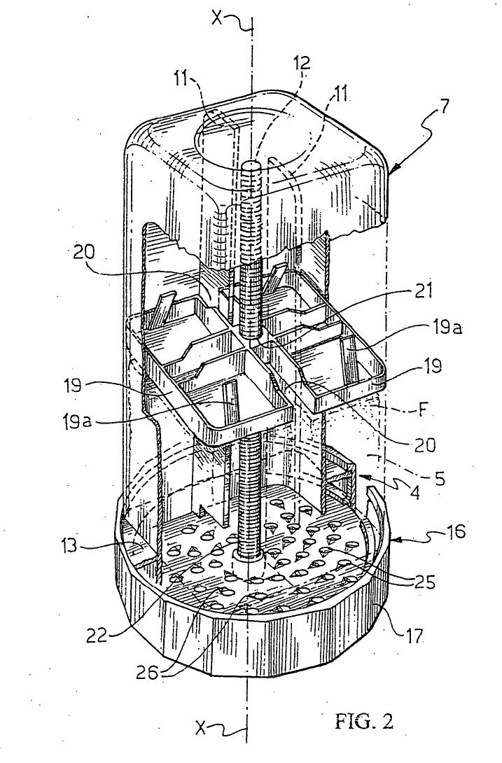

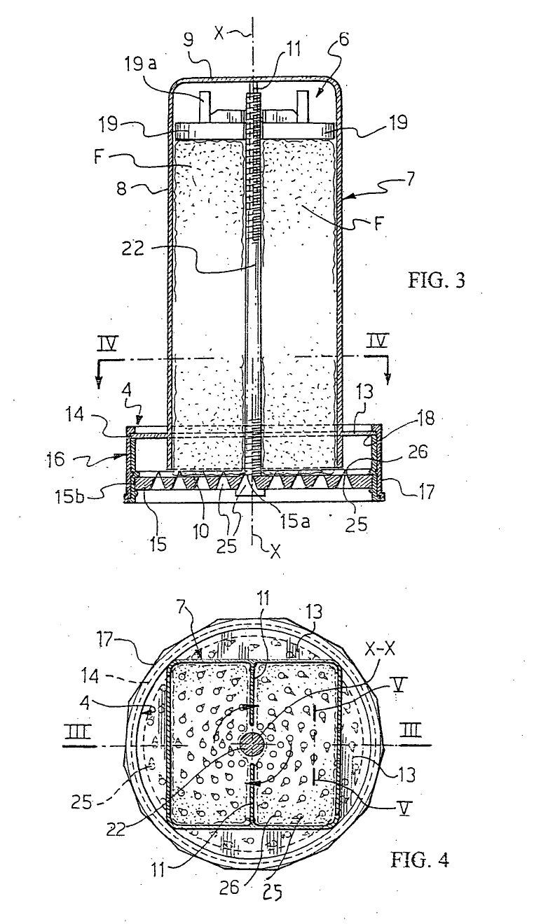

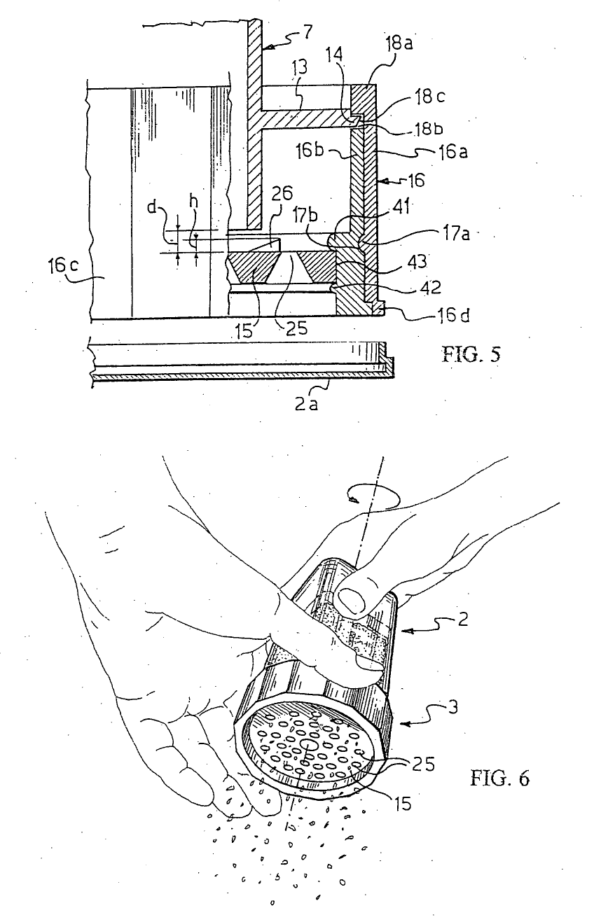

### DETAILED DESCRIPTION OF THE INVENTION

With reference to the attached drawings, globally and schematically shown at 1 is a cheese dispenser, particularly for mature cheese such as Parmesan-like cheese and the like, according to the invention.

The dispenser 1 comprises a container 2 for cheese and grating means 3. The grating means 3 are arranged so as to inviolably close the container 2. Coupling means 4, preferably irreversible trip means, are provided in order to secure the grating means 3 to the container 2.

In the container 2 a hollow 5 is formed to receive the cheese F and pushing means 6 are provided to push the product against the grating means 3. It should be noted that the cheese destined to occupy the hollow 5 is in its entire-state, in other words in one monolithic piece.

In particular the container 2 comprises a hollow body 7, which can be lengthened and substantially parallelepiped-like in squared section of axis x-x, having a mantle 8, closed at one end by a base 9 and provided with a mouth 10 at the opposite end.

Inside the hollow body 7 two vanes extend, both indicated with 11, longitudinal and projecting from two opposite walls of the mantle to define between each other a slot 12, longitudinal and narrowly extended along the axis x-x.

At its mouth 10, the hollow body 7 is equipped with a piece of a ring 13, of axis x-x, which projects from the mantle 8 of the body 7 and has a circular edge 14.

The grating means 3 comprise a disc 15, suitably drilled for grating the cheese, as it will be hereinafter described.

The disc 15, of axis x-x, has a central hole 15a, an external circular edge 15b, it faces the mouth 10 and it is located at a predetermined limited distance therefrom, indicated with d, e.g., 1.5 mm, substantially to close it. The disc 15 is kept in such an axial position with respect to the hollow body 7 by means of a sleeve 16.

The sleeve 16 comprises an external sleeve 16a and of an internal sleeve 16b, coaxially and forcedly arranged and axially tied by the mutual engage of an annular prominence 17a of the external sleeve with a swallow 17b of the internal sleeve. Between an end small edge 18a of the external sleeve 16a and an end 18b of the internal sleeve 16b a recess 18c is formed to receive, in a tied axial and rotably free way, the external circular edge 14 of the ring 13.

Inside the internal sleeve 16b two annular protuberances 41 and 42 are formed, in a mutual axially spaced relation substantially equal to the thickness of the disc 15, defining between one another a recess 43 for forcedly receiving, in a axially tied and rotation integral way, the circular external edge 15b of the disc 15.

It should be noted that advantageously the external sleeve 16a can have a polygonal periphery 16c, to facilitate the handgrip and a small edge 16d intended to receive at pressure, in a removable way, a cover 2a of semi-rigid plastic material, e.g., polyethylene, for protecting the hollow body 2 from the air.

Thanks to that indicated above, it is possible to control in rotation the hollow body 7, gripped for example with the right hand by the user, with respect to the grating means 3 gripped and held by the user with the other hand.

It should be noted that the pushing means 6 are made of a pusher plate 19, crosswise extended in the hollow body, with slots 20 for slidingly receiving the vanes 11 and with a central hole 21, threaded. In the central hole 21 a threaded stem 22 is screwly engaged, extended along the axis x-x and along the slot 12. The treaded stem 22 is rotation integral with the disc 15. In particular one end of the threaded stem 22 is engaged in the central hole 15a of the disc 15, and it can be made integral with said disc for example by injection molding on the threaded stem.

In practice, the vanes 11 and the threaded stem 22 divide the hollow 5 in two equal semi-hollows, each intended to receive respective pieces of cheese each being as a monolithical piece, in the form of a slim prismatic stick, with better slideway in the hollow body.

Advantageously, elastically springy tabs 19a project from the pusher plate towards the base 9 of the hollow body to push the pusher plate towards the threaded stem on the occasion of the first screw while assembling.

For grating the cheese in a granular form, in order to season pasta and the like, the disc 15 is provided with a plurality of holes 25 bell-mouthed outwards and equipped inwards with a tooth 26, of predetermined limited height h, e.g., 1 mm, meant to become rigid with the product to be grated.

Globally, the grating means 3 perform a grating activity on the product according to the needs.

According to the present invention the dispenser 1 is completed by an external casing 27, wherein the container 2 is housed, together with the grater 3 and the cover 2a. The casing 27 comprises a clear body 28 and a film 29 arranged to close the clear body 28. The clear body 28 is obtained by injection molding of a suitable plastic material, in the embodiment PET (polyethylentereftalat), with a wall thickness of around 1 mm, in order to provide a good resistance to the oxygen transition. The film 29 is obtained through lamination in a multilayer plastic material, having at least a barrier layer, comprised among layers of plastic material, e.g., PET. Barrier layer means a layer being particularly resistant to the oxygen transition, in EVOH (etilvinilalcohol) material, having a thickness from 5 to 10 micron (in the embodiment 5 micron). The film 29 is thermo-welded along its periphery at a small edge 28a of the clear body 28.

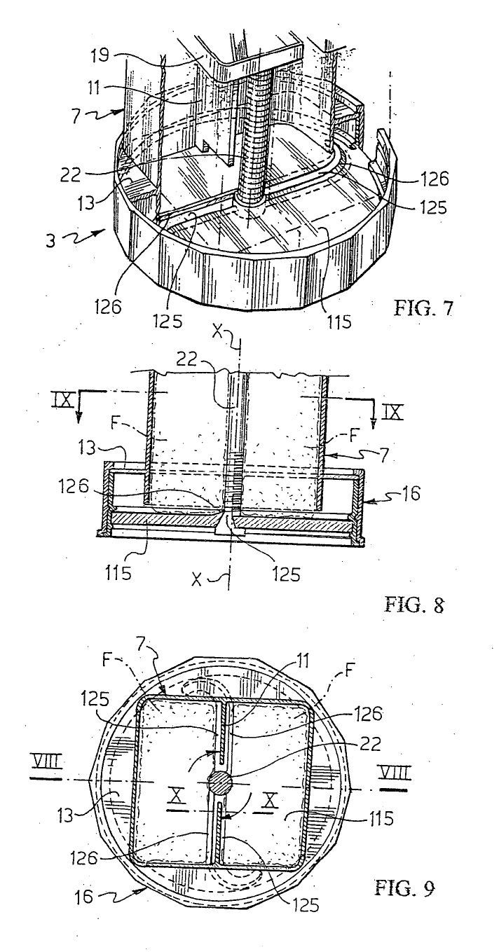

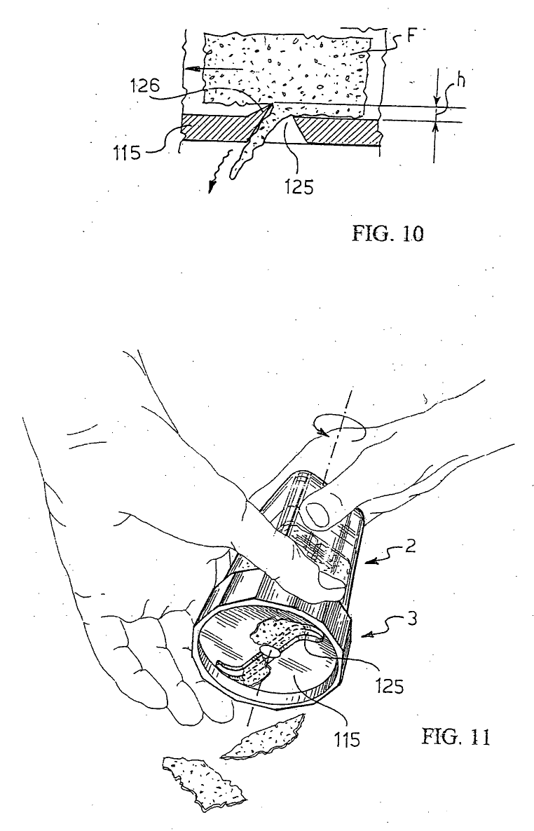

For grating the cheese in the foliated form, for garnishing or completing main courses such as thinly sliced raw meat, the present invention provides an alternate dispenser, which will be hereinafter described with reference to FIGS. 7, 8, 9, 10, 11, wherein the parts being structurally and functionally the same to those of the dispenser 1 have the same reference numbers.

In the dispenser, the grating means 3, comprise a disc 115, which is equipped with two opposite cutting slots 125, substantially radial and slightly sickle-like. The slots 125 are bell-mouthed outwards and they are equipped with a cutting thread 126, which leans inwards at a predetermined limited height h, in the embodiment 1 mm, intended to become rigid with the product to be grated, dispensing foliated cheese.

In use, the desired achievement of Parmesan-like grated cheese, in the granular or foliated form, is obtained by first strip-like removing the film 29 from the clear body 28, and throwing away the casing 27. So, by removing the cover 2a and thus handling the container 2 and the grater 3, in mutual rotation, as previously indicated. The user, at table, can put the container 2 in the cover 2a, used as small table-mat. At the end of the meal the container is tidied away, e.g., in the fridge, after having applied again the cover 2a to close it up, thus ready for a subsequent use until the cheese therein contained is completely consumed. At this point the container is thrown away.

The main advantage of the dispenser according to the present invention is that the preservation of the organoleptic characteristics of the cheese are remarkably improved, thanks to the fact that it is preserved in one piece until it is consumed in grated or foliated form.

A further advantage of the dispenser according to the invention is its improved hygienic quality, achieved because the product is almost non-touched by any hand contact.

A further advantage is that it is hygienically safe and protected from any unauthorized filling with lower quality products, due to the fact that it is inviolably closed, so as to be disposable, i.e., it can be used only once.

Finally, a last but not less important advantage, of the dispenser according to the invention is that it has a long shelf-life, obtained thanks to the casing, which is resistant to the oxygen transition.

It is also to be said that the dispenser according to the invention is suitable for an aesthetically pleasant realization so as to give value, while using it, to the environment it is destined to, both at home and in public premises.

Furthermore, the dispenser is structurally simple, so, a very large and low-cost production thereof is to be expected.

Obviously, in order to satisfy actual specific needs, a skilled person in the field will be allowed to make several variations to the above described invention, all within the scope of this invention as defined in the hereinafter listed claims.

1. Cheese dispenser, particularly mature cheese, such as Parmesan-like cheese and the like, characterized in that it comprises a container and a grater arranged to inviolably close the container.

2. Cheese dispenser according to claim 1, characterized in that it comprises trip coupling means between the grater and the container.

3. Cheese dispenser according to claim 1, characterized in that it comprises pushing means in the container, to push the cheese towards the grater.

4. Cheese dispenser according to claim 2, characterized in that grater is rotatably coupled to the container.

5. Cheese dispenser according to claim 3, characterized in that said pushing means comprise a threaded stem, rotationally integral with the grater and a pusher plate threadedly engaged by the threaded stem.

6. Cheese dispenser according to claim 1, characterized in that it comprises an external casing for the container and the grater.

7. Cheese dispenser according to claim 6, characterized in that the external casing comprises a body, in a plastic material of predetermined thickness, and a film of plastic material, arranged to close the body.

8. Cheese dispenser according to claim 7, characterized in that said film is of a multilayer plastic material, with at least a barrier layer.
